(19) United States
(12) Patent Application Publication
(10) Pub. No.: US 2015/0294330 A1
(43) Pub. Date: Oct. 15, 2015

(54) MARKET FORECASTING

(71) Applicant: Forecast International, Inc., Newton, CT (US)

(72) Inventors: Edward M. Nebinger, New Fairfield, CT (US); Elisabeth B. Zander, Goshen, CT (US); Mark Adam Waldorf, Seymour, CT (US)

(21) Appl. No.: 14/541,173

(22) Filed: Nov. 14, 2014

Related U.S. Application Data
(60) Provisional application No. 61/904,146, filed on Nov. 14, 2013.

(51) Int. Cl. G06Q 30/02

(52) U.S. Cl. CPC G06Q 30/0202

(57) ABSTRACT

An aspect of market forecasting is implemented by a memory and a computer processor communicatively coupled to the memory. The computer processor gathers, for a plurality of forecast years, data from a plurality of compartmentalized data sources. The computer processor determines, from the data, production forecast year, product unit price, and forecast amount for each product subject to the market forecasting. The computer processor also stores the data in corresponding data fields in a record in the memory, iterates through records in the memory that include the record to identify missing data in the data fields, calculates estimated values of the missing data as a function of contextual data in the record, and stores the estimated values in corresponding data fields in the record.

### DOMESTIC PRIORITY

This application claims the benefit of U.S. Provisional Application No. 61/904,146, filed Nov. 14, 2013, and entitled “Market Forecasting,” the contents of which is incorporated herein by reference in its entirety.

### BACKGROUND

The present invention relates to data processing, and more specifically, market data analysis and forecasting.

Many businesses, such as manufacturers and subcontractors, desire to identify opportunities with respect to future business projects in order to grow and sustain their businesses. Understanding future demand can be difficult, as there are many variables involved that influence the market.

By acquiring accurate and detailed business intelligence from a wide variety of sources, it may be possible to better predict future demand for resources offered by these businesses. Having this information can be extremely useful for planning purposes and may provide the businesses with a competitive edge.

### SUMMARY

Embodiments include a system, method and computer program product for market forecasting. The system includes a memory and a computer processor communicatively coupled to the memory. The computer processor is configured to gather, for a plurality of forecast years, data from a plurality of compartmentalized data sources. The computer processor determines, from the data, a production forecast year, product unit price, and forecast amount for each product subject to the market forecasting. The computer processor is also configured to store the data in corresponding data fields in a record in the memory, iterate through records in the memory that include the record to identify missing data in the data fields, calculate estimated values of the missing data as a function of contextual data in the record, and store the estimated values in corresponding data fields in the record.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system upon which market forecasting may be implemented according to an embodiment of the present invention;

FIG. 2 depicts a flow diagram describing a process for implementing market forecasting according to an embodiment of the present invention;

FIG. 3 depicts a flow diagram describing a process for implementing market forecasting according to an embodiment of the present invention;

FIG. 4 depicts a flow diagram describing a process for implementing market forecasting according to an embodiment of the present invention;

FIG. 5 depicts a diagram of an interface used in implementing market forecasting according to an embodiment of the present invention.

### DETAILED DESCRIPTION

According to an exemplary embodiment, market forecasting processes are provided. The market forecasting processes may be implemented through a relational database and interface that accepts information provided by analysts and external compartmentalized entities, integrates it and provides, through a graphical interface an instantaneous look at current, past, and future statuses of any market segment. The data are presented in the form of graphics depicted in many variations and selections. The user is able to drill-down and hover-over to obtain expanded information. Production forecasts are companied by a rationale that explains the reasoning behind the projections for a particular market. These and other features of the market forecasting processes will now be described.

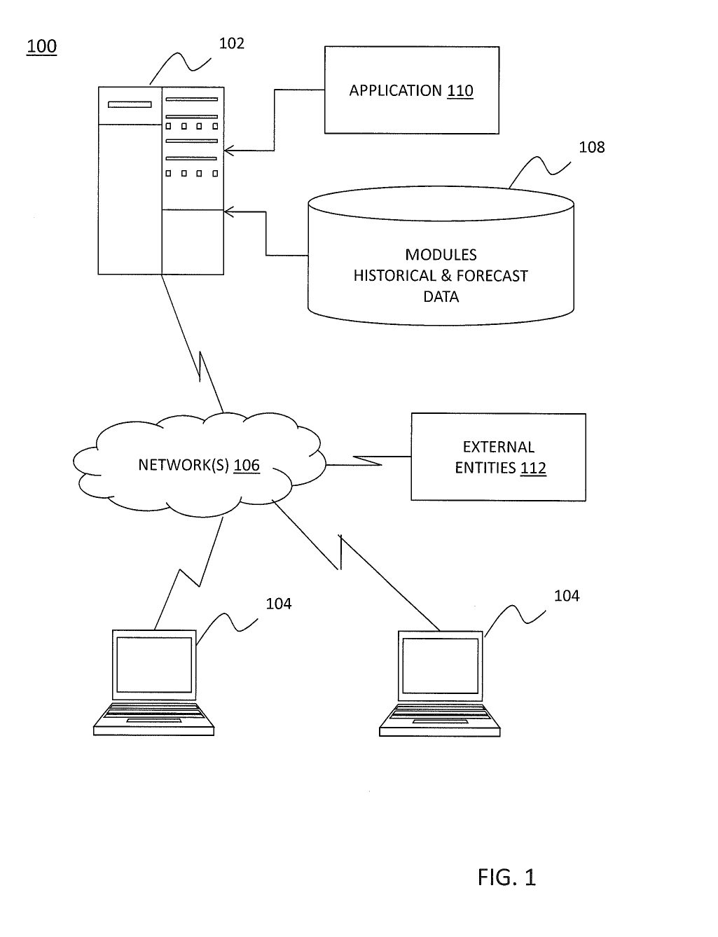

Turning now to FIG. 1, a system 100 upon which the market forecasting processes may be implemented will now be described in an exemplary embodiment. The system 100 of FIG. 1 includes a host system 102, user systems 104, and external entities 112, each of which is communicatively coupled to one or more networks 106. In one embodiment, the host system 102 executes computer instructions for implementing the exemplary market forecasting processes described herein. The host system 102 may represent a network server or other high-speed processing device that performs various transactions on behalf of users upon successful authentication to the network server. In an embodiment, the market forecasting processes are provided to end users on a subscription basis. Transactions may include, e.g., registration and renewal of the subscription services, search queries, and custom reporting features.

In an embodiment, the user systems 104 reflect subscribers, or end users of the market forecasting processes described herein. In another embodiment, at least one of the user systems 104 may be implemented by an analyst who compiles at least a portion of the data used in implementing the market forecasting processes. The user systems 104 may be general-purpose computer devices, such as desktop computers or laptops, or may be portable computer devices, such as tablet PCs and smartphones. If a user system 104 is operated by an analyst, in one embodiment, the user system 104 may be a host-attached terminal (e.g., in a client/server architecture).

External entities 112 may represent sources of data accessed and analyzed by the market forecasting processes. The sources of data are compartmentalized entities in that they may be each managed and maintained by separate, independent organizations, enterprises, or individuals. For example, an external entity 112 may be an industry-focused news source for a group or category of businesses.

The networks 106 may include any type of known networks including, but not limited to, a wide area network (WAN), a local area network (LAN), a global network (e.g. Internet), a virtual private network (VPN), and an intranet. The networks 106 may be implemented using a wireless network or any kind of physical network implementation known in the art. A user system 104 may be coupled to the host system 102 through multiple networks 106 (e.g., intranet and Internet) so that not all user systems 104 are coupled to the host system 102 through the same network. One or more user systems 104 and the host system 102 may be connected to the networks 106 in a wireless fashion.

The host system 102 is communicatively coupled to a storage device 108. The storage device 108 stores data relating to the market forecast processes and may be implemented using a variety of devices for storing electronic information. In an exemplary embodiment, the storage device 108 stores instructions used in providing the market forecasting processes as will be described herein. The storage device 108 may also store historical production data, as well as forecast production data for various market segments, as will be described herein. It is understood that the storage device 108 may be implemented using memory contained in the host system 102 or it may be a separate physical device. The storage device 108 may be logically addressable as a consolidated data source across a distributed environment that includes networks 106. Information stored in the storage device 108 may be retrieved and manipulated via the host system 102.

In an embodiment, the host system 102 operates as a database server and coordinates access to application data including data stored on the storage device 108. In an embodiment, the storage device 108 stores data in one or more relational databases.

The host system 102 depicted in FIG. 1 may be implemented using one or more servers operating in response to a computer program stored in a storage medium accessible by the server. The host system 102 may operate as a network server (e.g., a web server) to communicate with the user systems 104. The host system 102 handles sending and receiving information to and from the user systems 104 and can perform associated tasks.

The host system 102 may also operate as an application server. The host system 102 executes one or more computer programs to implement the market forecast processes. As shown in FIG. 1, the host system 102 these computer program(s) are implemented as application 110.

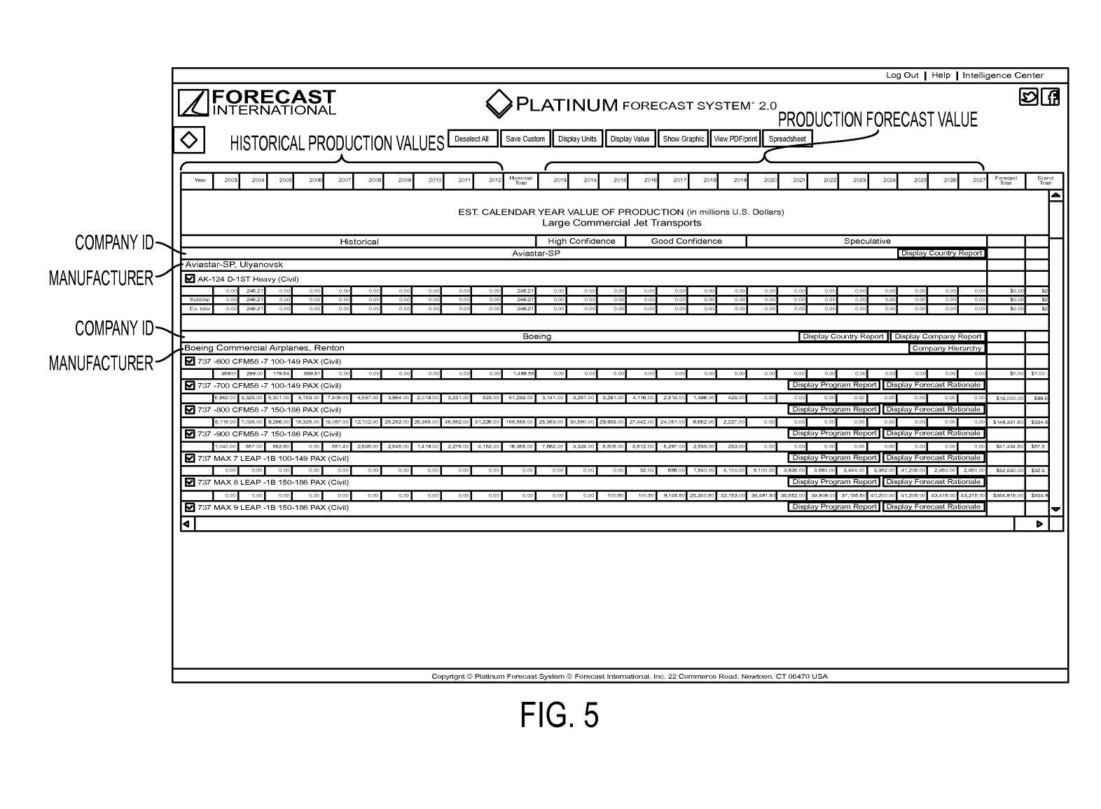

In an embodiment, the market forecast processes provide the ability to search for market data spanning a 25 year period of time. In an embodiment, ten years of historical data and fifteen years of future/forecasted data are provided for end user search queries (see, generally, FIG. 5). In order to provide this capability, twenty-five years of various types of data need to be captured and defined. In addition, the market forecasting processes determine future opportunities for a market and provide this information to end users.

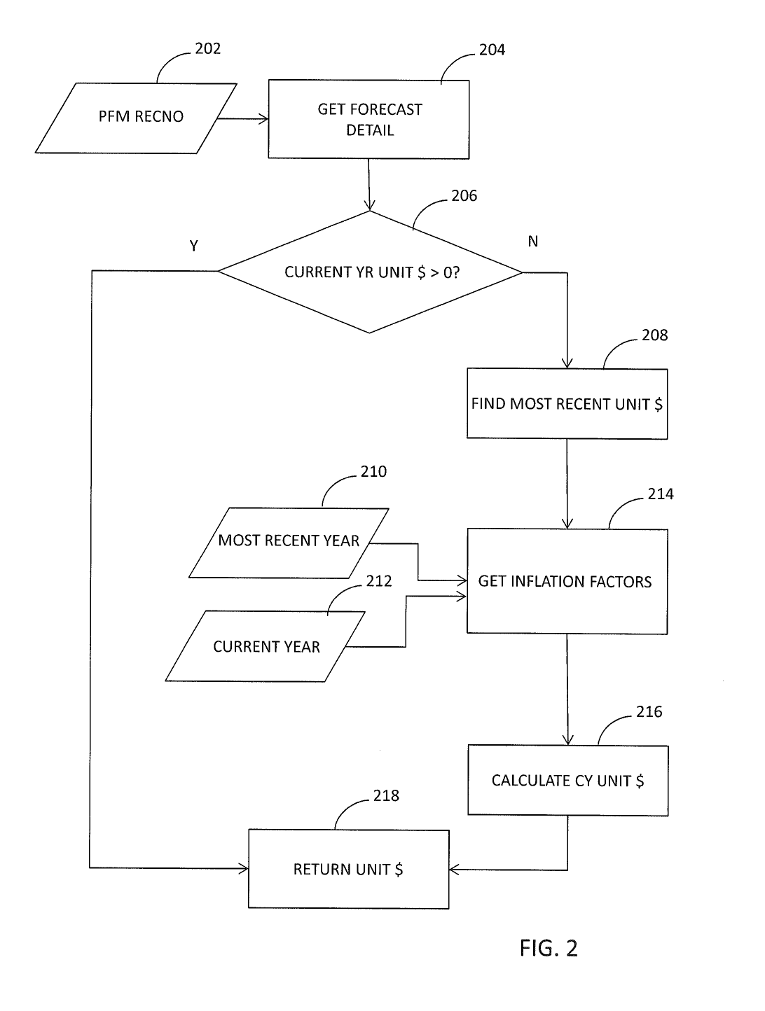

Turning now to FIGS. 2-5, process flows and a sample interface, each of which is implemented via the application 110, used in implementing the market forecasting processes will now be described in an exemplary embodiment. The sample interface shown in FIG. 5 illustrates output data for a 25-year period.

FIG. 2 describes a process in which a current unit price is calculated based on a most recent unit price on record. The current year unit price is calculated by obtaining the consumer price index (CPI) for the most recent year available and the current year. A formula is applied and the calculated current year unit price is returned.

In particular, the function detailed in this flow chart has a main input parameter 202 which is labeled as PFM recno (Production Forecast Master record number). Since the database is relational in nature, the PFM recno is used to relate the historical and forecast production data to a main table that describes what is being forecast in specific terms (for example, a 787-8 with GEnx engines holding between 187-250 passengers has PFM recno #11829). This number is an input parameter to the “Get Current Year Unit Price Function” which retrieves this information specific to that aircraft.

The record number for the aircraft in the above example is input to the function 204 which retrieves the forecast detail. The key elements contained in this record set include production year, unit price, and forecast amount. Unit price refers to the manufacturer's retail price for each assembled unit (e.g., the aircraft of the previous example) based on current year dollar pricing. The forecasted monetary value would be the product of that unit price by the number of units forecast for each production year record in the data set. If no current year unit price is available, then the one last with production is used. If the record set returned contains a record for the current year with a unit price greater than zero and a forecast amount greater than zero 206, then that unit price is returned 218. If there is no record that fits those criteria, then the most recent historical record (e.g., the year immediately preceding the current year, or the most recent year in which data is available) is found 208 and the inflation factor 214 between the current year 212 and the year for the most recent historical record 210 is then calculated, and the current year unit price is calculated 216 and returned 218 to a user. Inflation factors are determined 214 based on the most recent year 210 and the current year 212. In an embodiment, the current year unit price is a function of the most recent year's CPI index divided by the current year's CPI index, which result is then multiplied by the most recent year's unit price.

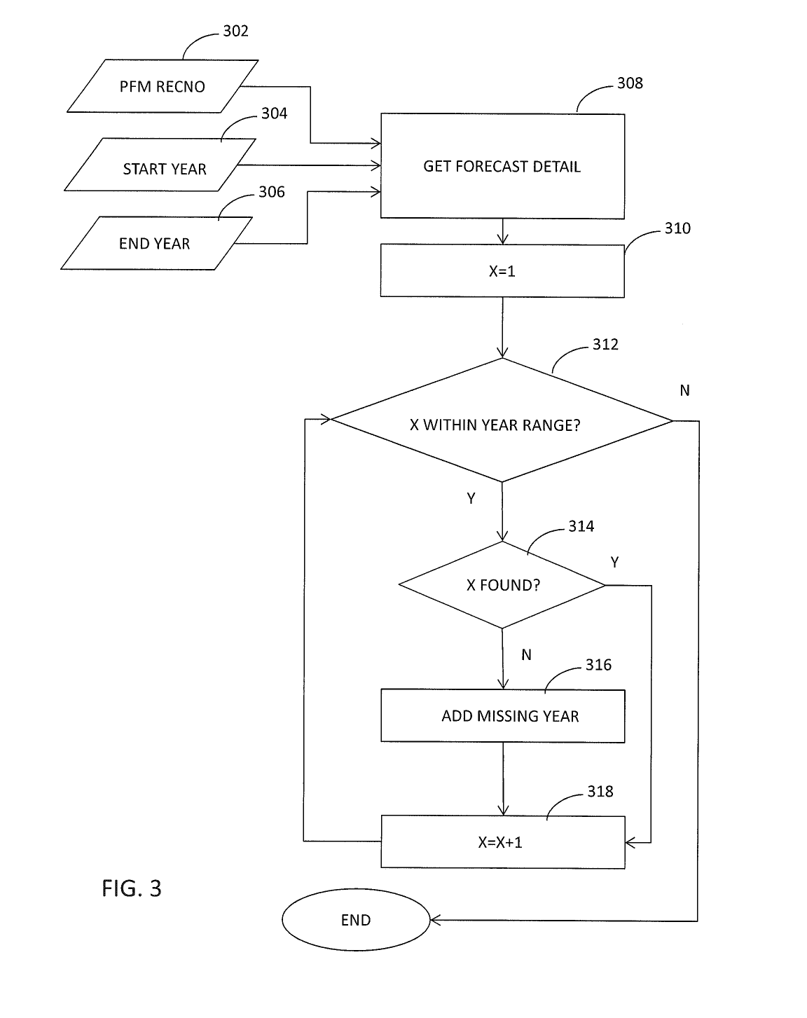

FIG. 3 describes a data normalization routine to handle gaps in data. In one case, production data may be limited because actual production terminated at a certain time. In another case, gaps are found in the data but both historical data and forecast data are available.

Data normalization uses the same production forecast master record number (PFM recno) 302 to get the related data (for example: a 787-8 with GEnx engines holding between 187-250 passengers has PFM recno #11829). The records returned contain a production forecast year, unit price, and forecast amount. The user has the ability to pick a starting year 304 and end year 306 on the website to control the years shown on the charts relating to the criteria they choose. These years 304/306, along with the PFM recno 302, are input to the function to get related production forecast detail 308. The function iterates through the data returned to verify that all years chosen by the end user are present in the system. If not, any gaps are filled in (added) to the dataset. Then, once verification is complete the “normalized” dataset is returned.

The iterative process is performed for each year in the production forecast detail, starting with a first year, expressed as ‘x=1’ 310. If the year x=1 is not within the user-specified year range 312, the process ends. This means that each of the years in the range has already been examined. If, on the other hand, the year falls within the range 312, the system determines whether data for that year has been found 314 in the forecast detail. If not, the system adds the data for the missing year 314, increments the year 318, and continues with the iteration process (312). Adding the missing data may be implemented by adding a record which indicates a zero production forecast for the missing year instead of showing no entry. In an embodiment, the process may be adapted to fill in data based on other formulas as determined by an authorized representative. The gaps may be flagged, and analysts of the services can review and make adjustments as needed. If the year, however, has been found 314 in the forecast detail, the system increments the year 318 and continues with the iteration process (312). This iterative process repeats until data for all of the years in the selected range have been examined.

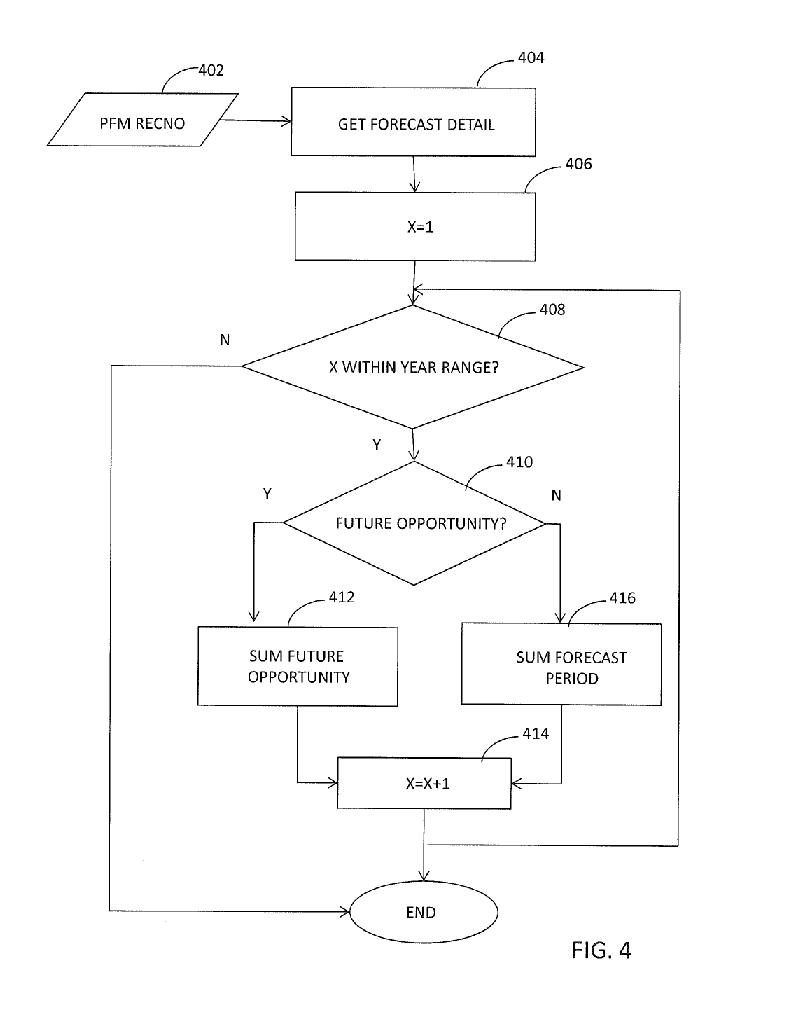

FIG. 4 describes a process relating to future opportunities. This may involve a fifteen year period beginning with the current year. A chart will display only if there is future opportunity for the market selected by the end user. If there is no future opportunity, the chart will not be in a list or otherwise displayed as the user cycles through the available charts.

As shown in FIG. 4, forecast data can be broken down into two main categories: 1) Forecast Production for which a manufacturer has been selected for a product forecast to be produced in the future, or 2) Forecast Opportunity for which there is a forecasted demand for a product, however, a manufacturer has not been selected, as would be otherwise indicated in the forecast data. The production forecast master record number (PFM recno) is input to this function. That master record contains all the pertinent information about what is being forecast. For example, pertinent information may include identification of a parent company, manufacturing company, a description of what is being forecast (Boeing 787® for example), and the buyer or country/region to which the item is to be delivered, if known. Future opportunity may be defined as something tangible being forecast for which there is no selected or available manufacturer. It could be for something that exists in the market place and for which there are multiple choices of manufacturer, or something that does not exist but for which there is a need. The detail returned by the function is then grouped into two categories: 1) Forecast Production, and 2) Future Opportunity. Since the user's selected criteria most likely contains more than one item being forecast, all data may be summed by year (starting with the current year and ending 14 years in the future, e.g., 2013-2027). This data is then used to present a chart to the user which summarizes the forecast production and future opportunity by year for their selected market (based the specific criteria chosen by the end user). As shown in FIG. 4, the future opportunity process begins with the input of the production forecast master record number (PFM recno) to the future opportunity function, which results in the forecast detail 404. An iteration process is performed to acquire data for all dates within the desired date range. As shown in FIG. 4, the first year analyzed is represented as ‘x=1’ 406. If the year x=1 is within the selected date range, the system determines whether the data represents a future opportunity 410 (e.g., no manufacturer has been selected). If so, the data is compiled in a summation (to be added to other years' data) of future opportunities 412, and the iteration is advanced to x=x+1, returning to 408. If the data does not represent a future opportunity 410, the data is compiled in a summation 9 to be added to other years' data) of forecast production 416, the iteration is advanced to x=x+1, and the process returns to 406.

In an embodiment, the market forecasting services include gathering, for a plurality of forecast years, data from a plurality of compartmentalized data sources (e.g., external entities 112). The services include determining from the data production forecast year, product unit price, and forecast amount for each product subject to the market forecasting. The services also include storing the data in corresponding data fields in a record in a memory (e.g., storage device 108), iterating through records in the memory that include the record to identify missing data in the data fields, calculating estimated values of the missing data as a function of contextual data in the record, and storing the estimated values in corresponding data fields in the record.

The iteration may be performed in response to a user search, which may include user-selected date ranges. The services also include calculating an estimated current year unit price for the product based on a most recent unit price for the product factoring in inflation. In addition, the services including determining, from forecast detail information stored in the record, summarized future opportunities and summarized forecast production. The summarized future opportunities indicate a forecasted demand for a product in which a manufacturer for manufacturing the product has not been selected, and the summarized forecast production indicate a forecasted demand for a product in which a manufacturer for manufacturing the product has been selected.

Further aspects of the embodiments will now be described.

Menu Components and Descriptions for Searches

There are 11 categories within the search menu that may be accessed via a pull down list via the user interface, as described herein.

Market Service/Segment

The application 110 is broken down into several different modules that may be individually purchased based on customer or subscriber focus areas. Searches can be performed on all services provided or based on a selected market, and even sub-market. For example, a service entitled Civil Aircraft Forecast may have a segment for large commercial jet transports, and a sub-market may include seat classes within the market. Based on the subscription, the user may also separately search military and civilian programs, or these may be searched together.

Platform Category

A user may select a type of platform and category for a search within any one market service. Examples of platforms include aircraft, electronics, engines, maritime vessels, munitions, satellites, etc.

System Data Type

The system data type further breaks down the chosen platform category. For example the platform category selection of aircraft is broken down into descriptors ‘fixed wing’ and ‘rotary wing.’

Category of Use

This option enables a user to narrow a search based on the various roles or applications of the platform category chosen. For example, the platform category of engines is broken out into specific categories of use such as APU, airliner AC, business jet, etc.

Worldwide Geography

This option enables a user to narrow a query by either Country or region of the world.

Other options include searching by company or manufacturer, converting between currencies, and graphical output choices (e.g., market trends, sub system values, value of production versus commingled (e.g., Research Development Test & Evaluation (RDT&E) and procurement), and future opportunity versus forecast production, which displays the forecast values by year without reference to a selected manufacturer.

The following is a list of standard graphical display choices and navigation options:

Unit Production (Multi-year bar graph). The unit production graphic depicts the number of historical or forecast units for each year in a data set. Each type of market can be represented using a different color in the graphic.

Value Statistics (Multi-year bar graph). The value statistics graphic depicts the value of historical or forecast production for each year in a data set. The selected report may be in U.S. currency during the chosen span of time. When a user hovers over any of the bars that represent years, a pop-up list appears that contains a listing of up to the top eight manufacturers, with the value of production in descending value and a total for the market at the bottom of the list.

Unit Production Percentage Market Share by Manufacturer. This graphic depicts the unit production percentage market share by manufacturer for the top industry players, all displayed in different-colored pie slices. Hovering over a slice, the number of total units will be displayed.

Value Production Percentage Market Share by Manufacturer. This graphic is similar to the Unit Production Percentage Market Share by Manufacturer above, except it reflects calculations of values in currency.

Unit Production Percentage Market Share by Descriptor. This graphic provides the user with the percentage breakdown by units for each of the descriptors.

Value of Production Percentage Market Share by Descriptor. This graphic provides the user with the percentage breakdown in values for each of the descriptors.

Value of Production Percentage Market Share by End User Country. This graphic provides the percentage and value of production for each of the top end user countries in a chosen currency. In an embodiment, this graphic enables a user to drill down into each country on the chart for greater detail.

Value of Production Percentage Market Share by End User Region. This graphic provides the percentage and value of production for each of the top end user regions in a selected currency. This graphic also enables the user to drill down into each region on the chart for greater detail.

Sub System Value. This graphic displays the value of each subsystem during each year for a period of twenty-five years. The Market Services or refined data sets all have different types of subsystems. In the Space System—Launch Vehicles & Manned Platforms service, e.g., there are six main subsystems and miscellaneous categories, each of which is displayed in a different color to provide a visual of the market size of each subsystem. The user may hover over any location in the graph to see more details.

Value Production versus RDT&E, Procurement & Commingled. This graphic displays the total value of purely production versus the value of research, development, testing, and evaluation, procurement and commingled. This graphic gives the user a sense of how much of the value of the total program is in the actual procurement of the programs or systems versus the financial expense of developing, purchasing and maintain them.

Future Opportunity Versus Forecast Production. This graph depicts the forecast production for up to fifteen years as compared to future opportunities. Future Opportunities are forecast values for production for which the manufacturer has yet to be selected. In other words, analysts are projecting production for market segment programs, but these programs have yet to be awarded to a particular manufacturer.

The market forecasting services are extendable to government and military activities. The services, selectable through an option on an interface of the application 110, provide a defense budget forecast that contains each of the line items of spending for the budget, including requested and appropriated amounts from Executive and Congressional branches. Each line item is described in detail with its own summary and also provides associated budge documents. These can be forecasted out several years.

In addition to the above-referenced information, the forecast marketing services also provide detailed rationales for forecasts entered in the system. This information may be accessed through a link displayed that corresponds to a forecast line item. The rationale provides the reasoning behind the forecast. This information can assist subscribers in better understanding the direction of a market. The rationales may be developed through analytical tools that collect information from various sources, and studies current and ongoing activities, business plans, and allocated budgets, for example.

Technical effects of the invention provide instant access to current, past, and future statuses of any market segment, including rationales for projected forecasts. Information provided by analysts and collected from external compartmentalized entities is integrated and is presented through a graphical interface. The data are presented in the form of graphics depicted in many variations and selections. The user is able to drill-down and hover-over to obtain expanded information. Production forecasts are companied by a rationale that explains the reasoning behind the projections for a particular market.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A system for market forecasting, comprising:
a memory; and
a computer processor communicatively coupled to the memory, the computer processor configured to:
gather, for a plurality of forecast years, data from a plurality of compartmentalized data sources;
determine, from the data, production forecast year, product unit price, and forecast amount for each product subject to the market forecasting;
store the data in corresponding data fields in a record in the memory;
iterate through records in the memory that include the record to identify missing data in the data fields;
calculate estimated values of the missing data as a function of contextual data in the record; and
store the estimated values in corresponding data fields in the record.

2. The system of claim 1, wherein the iteration is performed in response to a user search, the user search including user-selected date ranges.

3. The system of claim 1, wherein the computer processor is further configured to:
calculate an estimated current year unit price for the product based on a most recent unit price for the product factoring in inflation.

4. The system of claim 1, wherein the computer processor is further configured to:
determine, from forecast detail information stored in the record, summarized future opportunities and summarized forecast production.

5. The system of claim 4, wherein the summarized future opportunities indicate a forecasted demand for a product in which a manufacturer for manufacturing the product has not been selected.

6. The system of claim 4, wherein the summarized forecast production indicate a forecasted demand for a product in which a manufacturer for manufacturing the product has been selected.

7. A method for market forecasting, comprising:
gathering, for a plurality of forecast years, data from a plurality of compartmentalized data sources determining, from the data, production forecast year, product unit price, and forecast amount for each product subject to the market forecasting;
storing the data in corresponding data fields in a record in a memory;
iterating through records in the memory that include the record to identify missing data in the data fields;
calculating estimated values of the missing data as a function of contextual data in the record; and
storing the estimated values in corresponding data fields in the record.

8. The method of claim 7, wherein the iterating is performed in response to a user search, the user search including user-selected date ranges.

9. The method of claim 7, further comprising:
calculating an estimated current year unit price for the product based on a most recent unit price for the product factoring in inflation.

10. The method of claim 7, further comprising:
determining, from forecast detail information stored in the record, summarized future opportunities and summarized forecast production.

11. The method of claim 10, wherein the summarized future opportunities indicate a forecasted demand for a product in which a manufacturer for manufacturing the product has not been selected.

12. The method of claim 10, wherein the summarized forecast production indicate a forecasted demand for a product in which a manufacturer for manufacturing the product has been selected.

13. A computer program product for market forecasting, the computer program product comprising a storage medium embodied with program instructions, which when executed by a computer, causes the computer to implement:
gathering, for a plurality of forecast years, data from a plurality of compartmentalized data sources
determining, from the data, production forecast year, product unit price, and forecast amount for each product subject to the market forecasting;
storing the data in corresponding data fields in a record in a memory;
iterating through records in the memory that include the record to identify missing data in the data fields;
calculating estimated values of the missing data as a function of contextual data in the record; and
storing the estimated values in corresponding data fields in the record.

14. The computer program product of claim 13, wherein the iterating is performed in response to a user search, the user search including user-selected date ranges.

15. The computer program product of claim 13, wherein the method further comprises:
calculating an estimated current year unit price for the product based on a most recent unit price for the product factoring in inflation.

16. The method of claim 13, wherein the method further comprises:
determining, from forecast detail information stored in the record, summarized future opportunities and summarized forecast production.

17. The method of claim 16, wherein the summarized future opportunities indicate a forecasted demand for a product in which a manufacturer for manufacturing the product has not been selected.

18. The method of claim 16, wherein the summarized forecast production indicate a forecasted demand for a product in which a manufacturer for manufacturing the product has been selected.
